(19) United States
(12) Patent Application Publication
(10) Pub. No.: US 2007/0071874 A1
(43) Pub. Date: Mar. 29, 2007

(54) Cream compositions and food foams made therefrom

(76) Inventors: Mary Jean Cash, Wilmington, DE (US); Paquita Erazo-Majewicz, Newark, DE (US); Jeffrey K. Politis, Arden, DE (US)

Correspondence Address: Hercules Incorporated, 1313 N. Market Street, Wilmington, DE, 19894-0001, US

(21) Appl. No.: 11/529,085

(22) Filed: Sep. 28, 2006

Related U.S. Application Data
(60) Provisional application No. 60/721,332, filed on Sep. 28, 2005.

(51) Int. Cl. A23D 9/00

(52) U.S. Cl. 426/601

(57) ABSTRACT

This invention is directed toward cream compositions containing hydroxypropyl methylcellulose (HPMC), hydroxypropyl cellulose (HPC), methyl hydroxyethyl cellulose(MHEC), methyl cellulose (MC) or ethyl cellulose (EC), and their blends with water-soluble or water-swellable hydrocolloids. The cream compositions are useful in both dairy and non-dairy product compositions. The cream composition can be subjected to thermal processing to produce packaged products which are shelf-stable. The cream compositions are also useful in producing whipped compositions which exhibit a desirable appearance and amount of overrun.

### RELATED APPLICATIONS

This application claims the benefit of U.S. Provisional Application Ser. No. 60/721,332 filed on Sep. 28, 2005, which is incorporated by reference in its entirety.

### FIELD OF INVENTION

This invention is directed toward cream compositions containing hydroxypropyl methylcellulose (HPMC), hydroxypropyl cellulose (HPC), methyl hydroxyethyl cellulose(MHEC), methyl cellulose (MC) or ethyl cellulose (EC), and their blends with a water-soluble or water-swellable hydrocolloid as a stabilizer, and their use in non-dairy product compositions as well as milk or cream-based dairy product compositions. The cream or milk composition can be subjected to thermal processing to produce a shelf-stable milk or cream composition. This invention is also directed to the food foam or whipped product made from the cream compositions of the invention.

### BACKGROUND

Hydroxypropyl methylcellulose (HPMC) and methyl cellulose (MC) are polysaccharides used in a variety of applications to modify water absorption or the rheology of aqueous systems.

Hydroxypropyl methylcellulose is used in some food applications to add texture such as in puddings. The incorporation of HPMC into nonfat ice cream formulations has been described in J. Dairy Science, R. J. Baer et al, vol. 82: pp.1416-1424 (1999), but poor textural effects of the polymer on the ice cream texture were noted.

HPMC has been used in non-dairy whipped toppings, where it aids the development of foam and foam structure, U.S. Pat. No. 3,868,653 to Diamond et al. Other information regarding the use of HPMC in food applications is also available, such as available, such as www.Dow.Com/Methocel/Food for example.

GB 2248467A teaches the use of MC or hydroxymethyl cellulose in sterilized or pasteurized liquid food compositions to control the viscosity of these compositions during the sterilization or pasteurization step. Polymers such as hydroxypropylcellulose and hydroxypropyl methylcellulose have been used in the formulation of non-dairy whipped toppings to impart improved foam stiffness, and foam stability. In addition, hydroxypropyl cellulose allows the formulation of whipping creams with lower fat content, from the traditional 35-40% to as low as 24% fat, (Hercules Incorporated, Aqualon Division Technical Bulletin, VC-622A). Other polymers such as carrageenan and products that contain mixtures of polymers and emulsifiers, such as Aertex® cream stabilizer (Food Specialties, Mississauga, ON, Canada), which contains a blend of carrageenan, guar, locust bean gum and emulsifiers, have been added to whipping cream to achieve other functional benefits, see J. Dairy Science, A. K. Smith et al, vol. 82, pp. 1635-1642 (1999) and International Dairy Journal, A.K. Smith et al, pp. 295-301 (2000).

HPC has been used in non-dairy whipped toppings as a foam promoter and stabilizer and has also been used in dairy cream for whipping.

Microcrystalline cellulose co-processed with carboxymethylcellulose (MCC/CMC), for example Avicel® from FMC has been used in both dairy and non-dairy whipping cream for foam stabilization. MCC/CMC also has utility in low fat ice cream, dressings and desserts.

In dairy and non-dairy creams, HPC lowers the surface tension and interfacial tension as well as adds viscosity to the continuous phase. HPC acts to increase the rate of air incorporation during whipping decreasing whipping times and increasing overrun. HPC also improves foam stability and stiffness. HPC allows the formulation of reduced fat and low fat whipping creams by supplementing butterfat function in whipping.

MCC/CMC works as a viscosifier of the continuous phase to support and stiffen the foam. It also will reduce foam syneresis. MCC is used as a fat replacer and can impart some of fat-like texture to food systems.

### SUMMARY OF THE INVENTION

The present invention is directed to a cream composition comprising a cellulose ether compound, a water-soluble or water-swellable hydrocolloid stabilizer, a fat, and an aqueous phase, wherein the cellulose ether compound is selected from the group consisting of hydroxypropyl cellulose (HPC), hydroxypropyl methylcellulose (HPMC), methyl hydroxyethyl cellulose(MHEC), methyl cellulose (MC) and ethyl cellulose (EC) and blends thereof. The cream composition is further defined in such a manner wherein the water-soluble or water-swellable hydrocolloid stabilizer is selected from the group consisting of microcrystalline cellulose, hydroxyethyl cellulose, carboxymethyl cellulose, starch, carboxymethyl starch, hydrophobically modified starch, guar, pectin, pectinate, pectate, xanthan, carrageenan, agar, gellan, scleroglucan, betaglucan, alginate and alginic acid, propylene glycol-alginate, gum arabic, gum tragacanth, konjac gum, chitin, chitosan, locust bean gum, gelatin, and mixtures thereof.

The cream composition is of use in producing milk or cream-based dairy product compositions as well in the production of non-dairy cream compositions.

The present invention also accomplishes a process for producing the above referenced cream composition comprising combining a cellulose ether compound, a water-soluble or water-swellable hydrocolloid stabilizer, a fat and an aqueous phase together to obtain a cream composition, applying heat to the cream composition, optionally homogenizing the cream composition, and cooling the cream composition. The cream composition may also be subjected to thermal processing, such as pasteurization, High Temperature Short Time (HTST), or Ultra High Temperature (UHT) treatments, which produces a stable cream with desirable rheology, fat globules of small particle size, and good emulsion stability.

### DETAILED DESCRIPTION OF THE INVENTION

It has been unexpectedly found that incorporation of HPMC, HPC, MHEC, MC or EC or blends thereof with a water-soluble or water-swellable hydrocolloid as a stabilizer into creams, half creams, and reduced fat whipping cream formulations that have been subjected to thermal processing, such as pasteurization, High Temperature Short Time (HTST), or Ultra High Temperature (UHT) treatments, produces a stable cream with desirable rheology, fat globules of small particle size, and good emulsion stability. On whipping these cream compositions, the HPMC, HPC, MHEC, or MC or blends thereof with the water-soluble or water-swellable hydrocolloid improves the overrun or amount of foam delivered on whipping the cream, and the stability and texture of the resultant food foam is improved.

The cream compositions of the present invention, after whipping or through the incorporation of a gas phase, may exhibit overrun of greater than about 50%, preferably greater than about 95%, more preferably greater than about 110%, still more preferably greater than about 125%.

Additional improvements in physical characteristics and texture of the whipping creams is produced from the cream compositions and upon including emulsifiers into the compositions.

It has been further discovered that stiff, stable, aerated foams can be prepared from low fat systems, containing as low as 20% fat, using HPMC, MHEC, MC or HPC or blends thereof when used in combination with a water-soluble or water-swellable hydrocolloid and optionally emulsifiers. Emulsifiers useful in the invention may be selected from the group consisting of fatty acid esters of glycerol, hydroxycarboxylic acid, citric, acetic, lactylate, polyglycerol, ethylene or propylene glycol, ethoxylated derivatives of monoglycerides, and sorbitan fatty acid esters, lecithin, sodium stearoyl lactate.

The improvements observed on incorporation of HPMC, MHEC, MC and HPC into creams, especially whipping creams is also expected to be observed in the stability, whipping characteristics (per application), and texture of other creams, milks, and cream products and dairy products into which the cream or milk containing the HPMC, MHEC, MC or HPC is incorporated. Examples of dairy products include ice cream mixes, flavored milk, yogurt and yogurt beverages, acidified dairy beverages, dessert mixes and bases, coffee whiteners, evaporated milk, desserts and puddings, cheese sauces, dairy sauces, and nutritional supplement beverages.

Cream compositions described by this invention include any milk, cream, and cream product composition having a milkfat or vegetable fat level greater than 0.3 wt % comprising an emulsion of fat in an aqueous phase containing protein, lactose, minerals, and vitamins, derived from a cow, ewe, goat or other mammal or where the aqueous phase is derived from a vegetable source. Examples of milk, cream, and cream product compositions described by this invention are listed as a function of fat content in Table 1.

TABLE 1
Fat Content of various Milk, Cream, and Cream Product Compositions

| Cream Product | Fat/wt % |
|---|---|
| Skim Milk | up to 0.5% |
| Reduced Fat Milk | 0.5%-2.5% |
| Whole Milk | 3.5%-4.5% |
| Half-cream and single cream | 10-18% |
| Coffee Cream | up to 25% |
| Cake Cream | up to 40% |
| Cultured Sour Cream | up to 40% |
| Whipping Cream | 25-40% |
| Sweet Cream | up to 30% |
| Double Cream | >48% |
| Clotted Cream | >55% |
| High Fat Cream | up to 80% |
| Butter or Mock Creams | up to 30% |

Cream compositions described by this invention include half cream, sterilized half cream, cream or single cream, sterilized cream, whipped cream, whipping cream, double cream, clotted cream, extra-thick textured cream, spooning cream, fresh and frozen cream, heavy cream, culinary cream, reduced fat cream, table cream, half and half, coffee cream, sour cream, high fat cream, butter cream, and light cream. Examples of milks may include whole milk, reduced fat milk, flavored milk, chocolate milk, sweetened condensed milk, evaporated milk, and skim milk. Cream products may be enriched to varying degrees with milk fat, and they may be acidified, nonacidified, whipped, and may or may not have additives.

The compositions of the invention can be used for consumption on their own or for the manufacture of various food products such as dairy product compositions which may incorporate the cream composition of the invention. Examples of these dairy product compositions may include egg nog, ice creams and ice cream mixes, flavored milk, milk shakes, yogurt and yogurt beverages, neutral pH and acidified dairy beverages, dessert mixes and bases, cremes, coffee whiteners, evaporated milk, desserts and puddings, cheese sauces, dairy sauces, dips, dressings, low fat spreads, butter, low fat butter, fat-reduced butter, buttermilk, protein beverages, soups, condensed soups, liquid protein concentrates and preparations, cheese, processed cheese, cream cheese, whey protein concentrate, quarg products, nutritional supplement beverages, cream-based liqueurs, and gravies.

HPMC, MHEC, MC or HPC belong to a class of cellulose ethers which have long been used in many industries as viscosity control agents, emulsifiers, and binding agents. In the present invention, HPMC, MHEC, MC or HPC reduce the particle size of the fat component of the composition, and create a stabilized liquid dairy composition that remains stable even after thermal processing treatments.

The cellulose ether compounds used in the present invention may be prepared by any of a number of known methods. Generally, HPMC, MHEC, MC or HPC are prepared by the formation of an alkali cellulose by the addition of sodium hydroxide to a slurry of cellulose floc in a diluent. The alkali cellulose is then reacted with an alkyl halide, such as methyl chloride, or with a combination of an alkyl halide and an alkylene oxide, such as propylene oxide, or with propylene oxide alone under pressure. Thereafter, the slurry is neutralized and the product is extracted, dried and ground.

The cellulose ether compounds which are useful in the present invention are those which when incorporated into either dairy or non-dairy cream compositions in particular amounts, reduce or maintain the particle size of the fat phase of the composition. HPMC, MHEC, MC or HPC which are useful in the present invention are used in combination with other water-soluble or water-swellable hydrocolloids.

Examples of cellulose ether compounds which are useful in the present invention include hydroxypropyl methylcellulose and methylcellulose ethers commercially available as Benecel® product or Culminal® product from the Aqualon Division of Hercules Incorporated, METHOCEL® product, available from The Dow Chemical Company, Metolose™ product and Pharmacoat™ product, available from the Shinetsu Chemical Company, Tokyo, Japan, and Walocel® HM available from Wolff Cellulosics, a division of Bayer Material Science, Leverkusen, Germany. Examples of hydroxypropyl cellulose which is useful in the present invention include hydroxypropyl cellulose commercially available as AeroWhip®630 and 620 Whip Optimized solutions from the Aqualon Division of Hercules Incorporated and hydroxypropyl cellulose commercially available as Nisso® HPC from Nippon Soda. The cellulose ether compound is used in amounts ranging from greater than about 0.01% based on the total weight of the cream composition. Preferably, the cellulose ether compound is used in amounts ranging from greater than about 0.01% to less than about 1% based on the total weight of cream composition, more preferably in an amount ranging from about 0.1% to about 0.7%, still more preferably in an amount ranging from about 0.2% to about 0.5%.

The cream compositions of the invention contain fat at a level greater than or equal to about 0.3% by weight fat. Preferably, the cream compositions contain fat at level in the range of from about 0.3% to less that about 80% by weight fat, more preferably, at a level in the range of from 0.3% to about 40%, more preferably in the range from about 20 to about 25% by weight fat. The fat may be milkfat for dairy cream compositions. Alternatively, the fat may be an edible non-dairy fat such as a vegetable oil, such as soy bean oil or palm kernel oil.

The water-soluble or water-swellable hydrocolloids are included in the cream composition at concentrations of greater than about 0.001% by weight based on the total weight of cream composition. Preferably, the water-soluble or water-swellable hydrocolloids are included in the cream composition at concentrations in the range of greater than about 0.001% by weight to about 0.75%, more preferably in the range of greater than 0.01% to about 0.5%, still more preferably in the range of about 0.02% to about 0.05% by weight,

Water-swellable or water-soluble hydrocolloids include microcrystalline cellulose, including the material commercially available as Avicel® microcrystalline cellulose available from FMC Corporation, hydroxyethyl cellulose, hydrophobically-modified cellulose, hydrophobically-modified hydroxyethyl cellulose, ethyl hydroxyethyl cellulose, carboxymethyl cellulose, hydrophobically-modified carboxymethyl cellulose, ethyl carboxymethyl cellulose, methyl carboxymethyl cellulose, starch, carboxymethyl starch, ethyl starch, methyl starch, hydrophobically modified starch, guar, ethyl guar, methyl guar, hydrophobically-modified guar, hydroxypropyl guar, pectin and pectinate polymers, xanthan, carrageenan, agar, gellan, scleroglucan, betaglucans, alginate and alginic acid, hydrophobically-modified alginate, propylene glycol-alginate, gum arabic, gum tragacanth, konjac gum, chitin, chitosan and locust bean gum.

Examples of water-soluble or water-swellable hydrocolloid stabilizers useful in this invention may be selected from the group consisting of microcrystalline cellulose, hydroxyethyl cellulose, carboxymethyl cellulose, starch, carboxymethyl starch, hydrophobically modified starch, guar, pectin, pectinate, pectate, xanthan, carrageenan, agar, gellan, scleroglucan, betaglucan, alginate and alginic acid, propylene glycol-alginate, gum arabic, gum tragacanth, konjac gum, chitin, chitosan, locust bean gum, and mixtures thereof.

The cream composition also comprises an aqueous phase. This aqueous phase may be derived from a milk and would typically contain protein, lactose, minerals, and vitamins along with water. Alternatively, the aqueous phase may be derived from an alternative natural source such as a plant source, such as a vegetable or fruit and would typically contain proteins, sugars, minerals, vitamins along with water. Alternatively, the aqueous phase may be produced from water in which various ingredients, such as sugars, proteins, minerals, vitamins, flavorings, colorings may be added as desired,

Buffer salts, including but not limited to phosphates and citrates may be included in the composition.

The process for preparing the cream composition of the invention includes an initial step of dispersing HPMC, MHEC, MC, HPC, or blends thereof and the water-swellable or water-soluble hydrocolloids, in a portion of the milk or cream composition that has been heated above ambient temperature to improve dispersion of the hydrocolloids. The dispersion is then subjected to good mixing with sufficient shear in order to disperse and dissolve the hydrocolloids. When the dairy composition is a cream or reduced fat cream, the hydrocolloids may be dispersed in a portion of cream or whole or skim milk which is then added to the remainder of the volume of cream and mixing is continued to ensure complete dissolution or swelling of the cellulose ether compound as well as the water- swellable or water-soluble hydrocolloids. The mixture is then warmed to approximately 50-60° C., the mixture then undergoes thermal processing, and is homogenized before being finally cooled for packaging purposes.

The compositions of the invention are subjected to thermal processing or heat-processed to eliminate microbial contamination and to ensure a suitable product shelf-life. This heat-process exposes the composition of the invention to temperatures that would kill disease-causing microorganisms and/or reduce the numbers of spoilage microorganisms. Examples of the thermal processing include pasteurization, HTST processing, and UHT processing. Cream compositions which have been subjected to HTST or UHT processing are able to be aseptically packaged which permits these products to have an extended shelf-life.

Various types of heat exchangers can be used in this heat-processing step, including indirect plate heat exchangers(PHE), which are used for processing milk, flavored milk, fermented milk products such as drinking yogurt, as well as cream and coffee whiteners, indirect tubular-based heat exchanger systems, and scraped-surface heat exchangers.

The compositions of the invention may also be subjected to direct steam infusion into a steam chamber followed by rapid cooling or by direct injection of steam into the composition, followed by cooling with a PHE or tubular heat exchanger.

Examples of the heating apparatus used to thermally process the compositions of the invention include any indirect heating apparatus, including but not limited to a surface heat exchanger, a plate heat exchanger, a double pipe heat exchanger, a multi-pipe heat exchanger, a coil heat exchanger, a flat heat exchanger, and a scraped surface heat exchanger; including closed continuous-type scraped-surface heat exchangers, and direct heating apparatuses such as injection types and infusion types of heating apparatuses.

The cream compositions of this invention may also contain one or more ingredients commonly found in food and beverage products such as proteins, starches, flavors, fats, emulsifiers, coloring agents, opacifying agents, gums, binders, thickeners, preservatives, mold control agents, antioxidants, vitamins, emulsifying salts, sugars, amino acids, fat mimetics, and other ingredients known in the art.

The following examples will serve to illustrate the invention, parts and percentages being by weight unless otherwise indicated.

### EXAMPLES 1-7

### Pasteurized and Untreated Cream Formulations

Examples 1-7 contain pasteurized cream. The pasteurized cream formulations were prepared from a commercial ultra-pasteurized heavy cream (Garelick Farms heavy cream) containing no stabilizers and no emulsifiers. Skim milk or whole milk was mixed with the cream to obtain the desired fat level.

The pasteurized homogenized creams were prepared with heavy cream (heavy cream obtained from Garelick Farms) that was mixed with skim milk or whole milk, to obtain the desired fat content in the final cream. Pasteurization was conducted in a batch mode at 75° C. on a stove top for 10 minutes. The warm cream was then homogenized at 75° C. using a 2 stage pressure homogenizer (APV Gaulin), at 750/250 psi, and the product was immediately chilled in an ice bath to cool the cream.

### EXAMPLES 8-23

### UHT Processed Creams

Examples 8-23 UHT processed cream formulations. The UHT processed creams were prepared from pasteurized creams containing 31-34% fat with no added stabilizers or emulsifiers. Skim milk or whole milk was mixed with the cream to obtain the desired fat level.

The UHT processed creams were formulated and processed with light homogenization and ultra high temperature (UHT) treatment. UHT treatment is used to produce commercially sterile products for optimum shelf life. Batches were formulated with skim milk and heavy cream to obtain the desired fat level in the final cream. Ingredients were added to study the impact of no hydroxypropyl methylcellulose (HPMC), HPMC without an emulsifier present, HPMC with emulsifier, and HPMC blended with hydroxypropyl cellulose (HPC). Emulsifiers are often added to UHT treated whipping cream to aid in foam creation. All UHT processed formulations contained carrageenan, a common ingredient in heat treated cream to aid in the prevention of the coalescence of fat during storage and prior to whipping.

Table 2 contains formulation information; pasteurized or unheated batches were 1 liter batch sizes containing the ingredients shown in the top part of Table 2: Examples 1-7. UHT processed batches were 20 kg. UHT processed creams were prepared using the formulations shown in Table 3, Examples 8-23.

A mechanical high shear mixer with a shearing/dispersion blade was used for all mixing steps. The carrageenan and other polymers were added to the vortex of the appropriate amount of skim or whole milk or cream at 50-65° C. Stirring was continued for 10 minutes, until the temperature of the slurry cooled to 42° C. This slurry was then added to the cream portion at 10-15° C, and mixing was continued for an additional 20-30 minutes, until no visible gel particles were observed on the spatula. The viscosity of the creams increased after this mixing step. The cream was then heated to 50° C.-60° C. prior to introduction into the Microthermics processor.

UHT Thermal Processing

In all UHT processes the creams were subjected to a preheat temperature of 75° C. and final heat to 138° C. with a holding time of 8 seconds. Single stage cooling was used to achieve temperatures of <60° C. Pre-process 2-stage homogenization was provided to all products at a value of 750/250 psi using a homogenizer.

After mixing the cream composition, the cream mixture was then heated to 50-55° C. in a water bath and then pumped into a Microthermics Thermal processor at a flow rate of 1.14-1.2 Liters/min. The Microthermics unit was equipped with two sets of plate heat exchangers and a 2-stage pressure homogenization unit. The first set of PHE was used to preheat the cream to a temperature of 75° C. prior to introduction into the 2 stage homogenizer. After passing through the homogenizer, the cream was treated at a temperature of 138° C. for 8 seconds prior to being cooled to 50-60° C., and loaded into sterile Nalgene bottles in an aseptic-fill hood. The creams were stored at 4° C. until use in whipping applications or other studies. For Example 2, a Microthermics thermal processor was used, in a tubular heat exchanger configuration, with an 11.2 second hold time.

Cream Characteristics

Some physical properties and whipping cream characteristics for the creams are shown in Table 2.

Viscosity

Viscosities were measured on cream samples at specified temperatures using a Brookfield LVT Viscometer, jacketed small sample adapter attachment, with a constant temperature bath, using spindle #31 at 12 rpm for 10 ml samples and using spindle #18 for 7 ml samples, after 2 minutes. Samples were equilibrated to temperature for 30-60 seconds prior to the 2 minute viscosity measurement. The viscosity of the cream samples decreased as the temperature of the sample increased, with measurements shown at various specified temperatures from 4° C., 50° C., up to 75° C.

Whole milk samples( containing methyl cellulose or hydroxypropyl methylcellulose) were prepared in cold (4-8° C.) whole milk (Lehigh Valley Dairy Farms, Lansdale, Pa. by dispersing and mixing the polymer into the milk over 10 minutes using a Silverson mixer, followed by 10 minutes mixing using a dispersion blade on a Caframo mixer. The sample was examined for undissolved solids, allowed to stand for 1 hour, and the sample viscosity measured on a Brookfield LVT viscometer using a jacketed small sample adapter attachment, with a constant temperature bath, using spindle #18 or #31 at 12 rpm. Samples were equilibrated to temperature for 30-60 seconds prior to the 2 minute viscosity measurement.

Whipping Cream Measurements

Whipping creams were whipped using a Kitchen Aide mixer at high speed for three minutes using the following procedure:

Overrun

237.5 grams of cream were added to a prechilled stainless steel bowl, and 12.5 grams of 10× powdered confectioner's sugar were added to the cream while stirring at high speed. Mixing was continued for three minutes. Percent overrun was measured using a plastic Solo Brand P325 soufflé 3¼ oz. cup by adding the liquid cream to fill the cup and obtaining a weight for the cream. After whipping, the cup was then filled to the rim with the whipped cream and a second weight taken. % overrun was calculated according to the following formula:

$$\frac{Wt liquid cream - weight whipped cream}{weight whipped cream} = \% Overrun$$

Foam Syneresis

Foam syneresis was measured according to the following procedure:

Whipped cream was added to the rim of a 60×15 mm Petri dish. The dish was then inverted with foam side down, onto a Whatman No. 41 filter paper circle, on a metal pan. After 1 hour at room temperature, the increase in diameter of the wet circle imprint on the filter paper was measured to obtain the % extension of foam syneresis according to the following equation. A constant diameter of the foam in the Petri dish was measured as 50mm.

$$\% Syneresis = \frac{Diameter of wet syneresis ring ( mm ) \times 100}{50 mm}$$

Stiffness of Foam

Stiffness of the various whipped cream compositions were tested using a TAXTPlus texture analyzer from Stable MicroSystems with 5 kg load cell.

Stiffness was determined as the amount of force required to penetrate a sample of foam 5 mm using a 35 mm aluminum cylinder.

Instrument settings:
Test: Compression
Test Speed: 2 mm/sec
Distance: 5 mm
   1. Using filled soufflé cup from overrun measurement measure stiffness using TAXTPlus.
   2. Hold sample cup centered under probe.
   3. Select “run a test” via software on attached computer.

4. Record peak force in grams after test completion.

TABLE 2
Pasteurized and Untreated Cream Formulations

| | | | | | | | | Brookfield | | | | | |
|---|---|---|---|---|---|---|---|---|---|---|---|---|---|
| | | | | | | | | LVT Small | | | | | |
| | | | | | | | | Sample | | | | | |
| | | | | | | | | Adapter | Particle | | | | |
| | | | % | Stable | Pasturized/ | Whip to | % | Spindle 18 | size | | Viscosity | | |
| Exam- | % | Polymer | Poly- | (24 & | Homo- | Whipped | Over- | 12 rpm | (μm) | | (cps) | | |
| ple | Fat | Type | mer | 48 hrs) | genized | Cream | run | 2 min @15° C. | Median | Mean | 4° C. | 50° C. | 75° C. |
| 1a | 20% | None | 0 | | No | Did not | Did not | | | | | | |
| (Comp.) | Cream | Control | | | | whip, | whip | | | | | | |
| | | | | | | liquid | | | | | | | |
| 1b | 4% | None | 0 | | | | | 3.3 | | | | | |
| (Comp.) | Milk | Control | | | | | | (30 rpm) | | | | | |
| 2 | 20% | Carrageenan | 0.02 | yes | No | Did not | 90 | 18.9 | | | | | |
| (Comp.) | Cream | | | | | whip, | | | | | | | |
| | | | | | | foamy | | | | | | | |
| 3a | 20% | HPMC | 0.2 | Yes | No | Soft | 108 | | | | | | |
| | Cream | (Benecel ® | | | | | | | | | | | |
| | | MP333C) | 0.02 | | | | | | | | | | |
| | | Carrageenan | | | | | | | | | | | |
| 3b | 4% | HPMC | 0.6 | Yes | No | Soft | 108 | 186 | | | | | |
| (Comp.) | Milk | (Benecel ® | | | | | | | | | | | |
| | | MP333C) | | | | | | | | | | | |
| 3c | 4% | HPMC | 0.6 | Yes | No | Soft | 108 | 2017 | | | | | |
| (Comp.) | Milk | (Benecel ® | | | | | | (sp 31 | | | | | |
| | | MP874) | | | | | | 12 rpm) | | | | | |
| 3d | 4% | HPMC | 0.6 | Yes | No | Soft | 108 | 239 | | | | | |
| (Comp.) | Milk | (Benecel ® | | | | | | | | | | | |
| | | MP043) | | | | | | | | | | | |
| 4a | 20% | HPC | 0.2 | Yes | No | Soft, holds | 120 | | | | | | |
| | Cream | (AeroWhip ® | | | | small peak | | | | | | | |
| | | 630) | 0.02 | | | | | | | | | | |
| | | Carrageenan | | | | | | | | | | | |
| 4b | 31% | MC | 0.12 | Yes | Yes | Loose | 161 | | 3.05 | 3.4 | 635 | 277 | |
| | Cream | (Culminal ® | | | | whipped | | | | | | | |
| | | MHEC15000) | | | | cream, | | | | | | | |
| | | Carrageenan | 0.03 | | | more a | | | | | | | |
| | | | | | | dense | | | | | | | |
| | | | | | | foam | | | | | | | |
| 5 | 20% | HPC | 0.1/0.1 | Yes | No | Soft | 103 | | | | | | |
| | Cream | (AeroWhip ® | | | | | | | | | | | |
| | | 630/333C) | | | | | | | | | | | |
| | | Carrageenan | 0.02 | | | | | | | | | | |
| 6 | 22% | HPMC | 0.12 | Yes | No | Soft, hold | 119 | | | | | | |
| | Cream | (Benecel ® | | | | loose peak | | | | | | | |
| | | MP842) | 0.02 | | | | | | | | | | |
| | | Carrageenan | | | | | | | | | | | |
| 7 | 22% | HPMC | 0.12 | Yes | Yes | Soft, | 139 | | | | | | |
| | Cream | (Benecel ® | | | | holds peak | | | | | | | |
| | | MP842 | 0.02 | | | | | | | | | | |
| | | Carrageenan | | | | | | | | | | | |

Milks

Whole milk compositions containing Benecel® M043 methyl cellulose (Comparative Example 3d) or Benecel® MP333C or MP874 hydroxypropyl methylcellulose (Comparative Examples 3b, 3c) are shown in Table 1. Incorporation of the polymers into the whole milk increased their viscosity relative to the whole milk control sample containing no added polymer (Comparative Example 1b).

Creams

Comparison of the % overrun for Comparative Examples 3a and Examples 6, and 7 with Comparative Example 1a(control) demonstrate the improved overrun achieved on incorporation of HPMC into the creams. An improvement in overrun over the comparative control in Example 1a is also seen on blending Benecel ® MP333C HPMC with Aerowhip® 630 hydroxypropyl cellulose in Example 5. The pasteurization treatment for the cream in Example 7 yields a stable cream containing HPMC, with even greater overrun than prior to the heat treatment in Example 6.

TABLE 3
UHT PROCESSED

| | | | | | | Whip to |
|---|---|---|---|---|---|---|
| | | | % | Stable | UHT/ | Whipped |
| Example | % Fat | Polymer Type | Polymer | (24 & 48 hrs) | Homogenized | Cream |
| 8 (Comp.) | 36% | None control | 0 | Yes | Yes | May be |
| | | | | | | overwhipped, |
| | | | | | | almost like |
| | | | | | | butter |
| 9 (Comp.) | 36% | None added sugar control | 0 | Yes | Yes | Good whipped |
| | | | | | | cream, stiff, |
| | | | | | | holds peaks, a |
| | | | | | | little |
| | | | | | | dry/whipped 2 min. |
| 10 (Comp.) | 31% | None control | 0 | Yes | Yes | Soft, holds |
| | | | | | | peaks |
| 11 (Comp.) | 31% | Carrageenan | 0.03 | Yes | Yes | Barely |
| | | | | | | whipped, mor |
| | | | | | | a dense foam, |
| | | | | | | doesn't hold |
| | | | | | | peaks |
| 12 (Comp.) | 24% | Carrageenan | 0.03 | Yes | Yes | Sample did |
| | | | | | | not whip, still |
| | | | | | | a liquid |
| 13 (Comp.) | 15% | Carrageenan | 0.03 | Yes | Yes | Sample did |
| | | | | | | not whip, still |
| | | | | | | a liquid |
| 14 | 31% | HPMC(Benecel ® MP843) | 0.1 | Yes | Yes | Good stiff |
| | | Carrageenan | 0.03 | | | whipped |
| | | | | | | cream, holds |
| | | | | | | peaks |
| 15 | 31% | HPMC (Benecel ® MP943) | 0.1 | Yes | Yes | Good stiff |
| | | Carrageenen | 0.03 | | | whipped |
| | | | | | | cream, holds |
| | | | | | | peaks |
| 16 | 15% | HPMC (Benecel ® MP843) | 0.1 | Yes | Yes | Loose |
| | | Carregeenan | 0.03 | | | whipped |
| | | | | | | cream, more |
| | | | | | | of a dense |
| | | | | | | foam |
| 17 | 31% | HPC (AeroWhip ® 630) | 0.12 | Yes | Yes | Soft, holds |
| | | Carrageenan (Satiagel) | 0.02 | | | peak |
| | | | | | | Stiffer, holds |
| | | | | | | peak |
| 18 | 31% | HPMC (Benecel ® MP843) | 0.12 | Yes | Yes | Good whipped |
| | | Carrageenan (Satiagel) | 0.02 | | | cream, stiff, |
| | | | | | | holds peaks, |
| | | | | | | almost dry |
| 19 | 31% | HPMC (Benecel ® MP843) | 0.12 | Yes | Yes | Good whipped |
| | | Carrageenan (Satiagel) | 0.04 | | | cream, soft, |
| | | | | | | holds peaks |
| 20 | 31% | HPC (AeroWhip ® 30) | 0.03 | No | Yes | Good whipped |
| | | HPMC (Benecel ® MP843) | 0.09 | | | cream, stiff, |
| | | Carrageenan (Satiagel) | 0.02 | | | holds peaks, |
| | | | | | | not as dry as |
| | | | | | | Ex 14, very |
| | | | | | | smooth |
| 21 | 31% | HPC (AeroWhip ® 630) | 0.06 | Yes | Yes | Good whipped |
| | | Carrageenan (Satiagel) | 0.02 | | | cream, soft, |
| | | | | | | holds peaks |
| 22 | 31% | HPMC (Benecel ® MP843) | 0.12 | No | Yes | Good whipped |
| | | Carrageenan (Satiagel) | 0.02 | | | cream, stiff, |
| | | lactic acid esters | 0.15 | | | holds peaks |
| | | monoglycerides Ginnsted | | | | |
| | | Lactem ® | | | | |
| | | P22K emulsifier | | | | |
| 23 (Comp.) | 31 | Carrageenan (Satiagel) | 0.02 | No | Yes | Soft, holds |
| | | | | | | peaks |

| | | | Particle | | | | |
|---|---|---|---|---|---|---|---|
| | | | size | | Viscosity | | |
| | % | % Extension | (μm) | | (cps) | | |
| Example | Overrun | of Syneresis | Median | Mean | 4° C. | 50° C. | 75° C. |
| 8 (Comp.) | 75.2 | Not taken | No | No | 30.0 | No | No |
| | (3 min.) | | | | | | |
| 9 (Comp.) | 94.56 | 3.3 | No | No | 30 | No | No |
| | (2 min., | (30 rpm) | | | | | |
| | 20 sec.) | | | | | | |
| 10 (Comp.) | 104 | 64.69 | 5.36 | 6.60 | 150.3 | 20.3 | 14.0 |
| | (3 min.) | | | | | | |
| 11 (Comp.) | 94.65 | 45.6 | 6.62 | 7.27 | Gel- | 750 | 49.0 |
| | | | | | like | | |
| 12 (Comp.) | 69.92 | Not taken, | 12.34 | 14.78 | 91000 | 1565 | 542 |
| | | still a liquid | | | | | |
| 13 (Comp.) | | Not taken, | | | 675 | 38.0 | 1.50 |
| | | still a liquid | | | | | |
| 14 | 129.2 | 28.5 | 4.24 | 4.73 | 1340.0 | 222 | 5.5 |
| 15 | 130.87 | 33.41 | 4.37 | 4.86 | 1062 | 160 | 4.7 |
| 16 | 149.19 | 53.14 | 11.14 | 11.81 | 640.0 | 100 | 1.5 |
| 17 | 140 | 23.2 | 4.03 | 5.47 | 915.0 | 113.5 | 61.3 |
| | (2 min.) | | | | | | |
| | 138 | 23.2 | | | | | |
| | (3 min.) | | | | | | |
| 18 | 128 | 63.2 | 1.99 | 2.53 | 567.5 | 35.6 | 22.0 |
| | (3 min.) | | | | | | |
| 19 | 130 | 35.90 | | | | | |
| | (3 min.) | | | | | | |
| 20 | 142 | 63.20 | 2.12 | 2.56 | 390.0 | 45.0 | 20.8 |
| | (3 min.) | | | | | | |
| 21 | 134 | 35.62 | 8.82 | 9.75 | 1602.0 | 107.5 | 83.0 |
| | (3 min.) | | | | | | |
| 22 | 144 | 31.1 | 1.68 | 2.13 | 502.0 | 37.8 | 20.3 |
| | (3 min.) | | | | | | |
| 23 (Comp.) | 116 | 51.42 | 7.21 | 7.90 | | | |
| | (3 min.) | | | | | | |

For UHT processed creams, comparison of the median particle size for the creams containing HPMC in Examples, 14,15, 18, 20, and 22 and for creams containing HPC in Example 17, with Comparative Examples 10 and 11 in Table 2 demonstrates the positive effect of HPMC or HPC on reduction of the particle size of the fat in cream, a desirable attribute for improved mouthfeel. The addition of HPMC or HPC to the creams also has a positive effect on incorporation of air into the whipped cream, as measured by the amount of overrun. The amount of overrun observed for HPMC examples 14, 15, 18, 19, 20, and 22, or for HPC Examples 17 and 21, is greater than the amount measured for the control creams in Comparative Examples 10, 11, and 23. Good overrun and small particle size are also obtained on blending the HPMC with HPC as shown in Example 20. All of the creams whipped to good foams which held peak structure. Even the very low fat cream containing HPMC in Example 16 produced a dense foam on whipping compared with a liquid foam of the low fat control in Comparative Example 13.

Inclusion of HPMC in the cream formulation had a positive effect on the length of the UHT process run times for Examples 14 and 15 when compared with the control run in Comparative Example 11. The UHT process ran for longer times with Examples 14 and 15, with greater control over the hold tube temperature and the heating and cooling water temperatures than observed in the control Comparative Example 11. Less fouling was observed on the plate heat exchangers (PHE) in Examples 14 and 15, and the PHE were more easily cleaned after completion of these runs than observed with the control Comparative Example 11. A similar improvement in UHT process run time, reduced fouling, control over the hold tube temperature and heating and cooling temperatures during UHT processing, as well as easier cleaning of the PHE was observed on inclusion of HPMC in Example 16 when compared with the control run in Comparative Example 13.

Inclusion of HPMC or HPC in the cream formulation also had a positive effect on reducing the syneresis of the whipped cream as observed on comparing the extent of syneresis in Table 3 for Examples 14 and 15 with Comparative Example 11, on comparison of the extent syneresis in Table 3 for Example 17 with Comparative Example 2, and on comparing the extent of syneresis for control Comparative Examples 11 and 23 with Examples 19 when the amount of carrageenan in the formulation was increased from 0.02% to 0.04% or when an emulsifier was included in the formulation (Example 22). These results suggest that additional optimization of component ratios in the creams containing HPMC or HPC would improve the cream functionality.

Similar positive effects on % overrun and syneresis of ice creams are expected when HPMC, HPC, MHEC, or MC are included in these formulations.

### EXAMPLES OF 20% FAT WHIPPING CREAM COMPOSITIONS

Examples 28-30 demonstrate the improved stability of liquid creams combined with improved whipping performance of these creams upon incorporating HPC or HPMC with a water-soluble or water-swellable polymer and an emulsifier. Other aerated dairy systems, incorporating the creams of the present invention, such as ice cream, desserts, and cooking creams that can be whipped, may benefit from the combination of HPC or HPMC with water-soluble polymers such as CMC, carrageenan, guar, locust bean gum, or their combinations. Examples 24-27 are provided as comparative control examples.

For the processing, testing and evaluation of various cream compositions containing a lower fat content of 20% by weight as embodied in Examples 24-30, the following methods and conditions were used.

Cream Processing

1. Mix dry powders hydroxypropyl cellulose, hydroxypropylmethyl cellulose, CMC, carrageenan, solid emulsifiers together in skim milk using Silverson to incorporate, add liquid emulsifiers. Continue mixing with Silverson for 20 minutes.
2. Mixing was continued for 1 hour with good agitation (1000 rpm) using a mechanical stirrer equipped with a Jiffy blade.
3. The skim milk mixture was added to the cream and mixed with low agitation for 30 minutes.
4. The cream was processed under UHT conditions using a MicroThermics thermal processor with the following parameters:
Preheat 78° C.
Sterilize 138° C.
1^{st} cooler 78° C.
Homogenize 1500/500 psi; 1000 psi, or 750/250 psi as shown in Table 4 2^{nd} cooler 10 C
Creams were tested for viscosity 2 hours after production. Viscosity and whipping characteristics were tested after 24 hours and approximately 3 weeks.
   Testing
   Whipping % Overrun, Whipped Creams Observations
1. Weigh cream into tared stainless souffle cup. Scrape straight edge across top to remove excess liquid. Record weight as “before aeration.”
2. Weigh 380 g cream and 20 g (10%) 10× sugar into previously chilled Kitchen Aide mixing bowl. Secure bowl to mixer.
3. Attach previously chilled whipping attachment to mixer. Mix for 1 minute at half speed, add sugar
4. Raise bowl and whip at full speed until maximum overrun is achieved (foam pulls from the sides of the bowl and forms peaks when mixer attachment is removed). Record whipping time.
5. Weigh/overfill whipped cream into tared Solo 2oz. plastic souffle cup. Scrape straight edge across top to remove excess whipped cream. Record weight as “after aeration”.
6. Calculate % overrun:

$$\% Overrun = \frac{wt . ( g ) cream before aeration - wt . ( g ) cream after aeration}{wt . ( g ) cream after aeration} \times 100$$

Observe and record whipped cream texture and ability to hold peak.

TABLE 4
20% Fat Whipping Cream Compositions

| | Comparative | Comparative | Comparative | Comparative | | | |
|---|---|---|---|---|---|---|---|
| | Example 24 | Example 25 | Example 26 | Example 27 | Example 28 | Example 29 | Example 30 |
| | % | % | % | % | % | % | % |
| Ingredient | | | | | | | |
| Skim Milk | 49.450 | 49.050 | 49.500 | 49.100 | 48.935 | 48.825 | 48.925 |
| HPC (Aerowhip ® 631EZ) | 0.400 | 0.400 | | | 0.240 | 0.200 | |
| HPC (Aerowhip ® 640X) | | | 0.350 | 0.350 | | | 0.300 |
| HPC (Aerowhip ® 600) | | | | | 0.400 | 0.400 | |
| Carboxymethyl Cellulose | | | | | 0.100 | 0.100 | |
| (CMC 7HOF) | | | | | | | |
| Carrageenan (Abuygel ™) | | | | | | | 0.025 |
| Carrageenan (Satiagel ™) | | | | | 0.025 | 0.025 | |
| CC445 | 0.150 | 0.150 | 0.150 | 0.150 | 0.150 | 0.150 | 0.150 |
| Emulsifier (Grinsted Lactem ™ P22) | | | | | | 0.150 | 0.600 |
| Polysorbate 80 (Tween ™ 80) | | 0.400 | | 0.400 | | | |
| HPMC (Benecel ® MP843) | | | | | 0.150 | 0.150 | |
| 40% Cream | 50.00 | 50.00 | 50.00 | 50.00 | 50.00 | 50.00 | 50.00 |
| Total | 100.00 | 100.00 | 100.00 | 100.00 | 100.00 | 100.00 | 100.00 |
| Homogenation Pressure (psi) | | | | | | | 1500/500 |
| Liquid cream characterization | | | | | | | |
| Viscosity @ 12 rpm | | | | | | | 2070 |
| Median particle size | | | | | | | 1.67 |
| Mean particle size | | | | | | | 1.87 |
| Whipped Cream Performance | | | | | | | |
| Whip time (sec.) | | | | | | | 600 |
| % Overrun | | | | | | | 180 |
| Stiffness/grams force | | | | | | | 42 |
| Cream Stability | | | | | | | 5 |
| (5 = stable; 3 = some flocculation; | | | | | | | |
| 0 = phase separation/strong syneresis) | | | | | | | |
| Homogenization Pressure (psi) | 750/250 | 750/250 | 750/250 | 750/250 | 750/250 | 750/250 | 1000 |
| Liquid Cream Characterization | | | | | | | |
| Viscosity (cps @ 12 rpm sp. 31SSA) | 98 | 50 | 1350 | 468 | 2308 | 1878 | 2100 |
| Median particle size (microns) | 1.64 | 0.81 | 2.04 | 1.14 | 3.84 | 3.28 | 2.3 |
| Mean particle size (microns) | 1.17 | 0.86 | 2.13 | 1.27 | 4.29 | 3.56 | 2.51 |
| Whipped Cream Performance | | | | | | | |
| Whip time (sec.) | 480 | 600 | 600 | 600 | 600 | 600 | 600 |
| % Overrun | 180 | 105 | 174 | 99 | 99 | 159 | 224 |
| Stiffness (gm of force) | 10 | 95 | 12 | 113 | 48 | 44 | 82 |
| Cream Stability | 3 | 0 | 5 | 0 | 4 | 5 | 5 |
| (5 = stable; 3 = some flocculation; | | | | | | | |
| 0 = phase separation/strong syneresis) | | | | | | | |

### COMPARATIVE EXAMPLES 24 to 27: 20% FAT WHIPPING CREAMS

Comparative Examples 24 and 26 demonstrate the performance of hydroxypropyl cellulose of two different molecular weights in a UHT processed cream containing 20% fat and a phosphate salt/citrate salt blend. These examples contain no second hydrocolloid thickener. Stability of the cream in Example 24 is poor, with flocculation and syneresis observed after 1 month storage at 4° C. Stability of the cream in 26 is good, with no syneresis or phase separation observed after two months at 4° C. The % overrun for these samples is greater than 150%, however, the stiffness of the foam is poor, having less than 20 grams force resistance as measured on a TAXT-2 analyzer.

Comparative Examples 25 and 27 demonstrate the improvement of foam stiffness in the creams of Example 24 and 26 upon incorporation of polysorbate 80 emulsifier. The polysorbate emulsifier, however, destabilized the liquid cream emulsion, leading to low stability ratings and phase separation of the cream.

### EXAMPLES 28 to 30: 20% FAT WHIPPING CREAMS

Examples 28 and 29 of the present invention demonstrate the performance of a blend of hydroxypropyl cellulose polymers of two different molecular weights with hydroxypropylmethyl cellulose in a UHT processed cream containing 20% fat and a phosphate salt/citrate salt blend. Examples 28 and 29 also contain water-soluble hydrocolloids, carrageenan and carboxymethyl cellulose (CMC) which improve the stability of the cream, as shown by the high stability rating for the cream. Incorporation of lactic acid emulsifier into Example 30 improves the overrun of this cream.

In addition to the improved stability of the liquid creams in Examples 28 and 29, the whipped cream stiffness is significantly improved over the stiffness of the whipped creams in Examples 24 and 26. The cream in Example 29 has good overrun, it forms a stiff foam, and it is also a stable liquid cream, as shown by its high stability rating.

Example 30 of the present invention demonstrates the improved performance of hydroxypropyl cellulose in a UHT processed cream containing 20% fat with carrageenan as the hydrocolloid thickener. Lactic acid emulsifier is also present in this cream. This cream was prepared under two homogenization pressures, 1500/500 psi and a second sample was prepared under 1000 psi homogenization pressure. Both creams are stable (stability rating of 5) and whip to a high overrun (>150%). The cream prepared at 1000 psi homogenization pressure formed a stiffer foam (>80 grams force).

Examples 31-33 demonstrate the improved cream stability and better whipped cream performance of creams containing HPC or HPMC with a water-soluble or water-swellable hydrocolloid, such as microcrystalline cellulose (MCC) than obtained with either HPC or MCC used alone.

### EXAMPLES 31-36: 24% FAT WHIPPING CREAM

Examples of a 24% fat whipping cream composition was made using combinations of HPC as the cellulose ether compound (AeroWhip® 631 EZ, available from Aqualon Division, Hercules Incorporated) in combination with a microcrystalline cellulose (MCC) (Avicel® microcrystalline cellulose available from FMC Corporation) and a carrageenan (Satiagel™ ACL15 carrageenan available from Cargill, Incorporated) a water-swellable or water-soluble hydrocolloids

The formulations of these whipping cream compositions are as follows:

| | Example | Example | Example | Example | Example | Example |
|---|---|---|---|---|---|---|
| | 31 | 32 | 33 | 34 | 35 | 36 |
| | wt % | wt % | wt % | wt % | wt % | wt % |
| HPC (AeroWhip ® 631 EZ) | 0.2 | | 0.1 | | 0.1 | |
| HPMC (Benecel ® MP 843) | | | | | | 0.2 |
| MCC (Avicel ® CL 611) | | 0.5 | 0.2 | | | |
| MCC (Avicel RC 591) | | | | 0.2 | 0.2 | 0.1 |
| Carrageenan (Satiagel ACL15) | 0.02 | 0.02 | 0.02 | 0.02 | 0.02 | 0.02 |
| Polysorbate 80 (Tween 80) | 0.15 | 0.15 | 0.15 | 0.15 | 0.15 | 0.15 |
| Skim milk | 39.63 | 39.33 | 39.53 | 39.63 | 39.53 | 39.53 |
| 40% wt % fat dairy cream | 60 | 60 | 60 | 60 | 60 | 60 |
| Total | 100 | 100 | 100 | 100 | 100 | 100 |

The process to produce the whipping creams of the above Examples are as follows:
1. Mix HPC, HPMC and/or MCC and carrageenan dry powders together.
2. Add to skim milk using Silverson to incorporate, add Tween. Continue mixing with Silverson for 10 minutes.
3. If the formulation contained HPC, or HPMC or MCC grade RC 591, mixing was continued for 1 hour with low agitation using a Caframo overhead style mixer.
4. The skim milk mixture was added to the cream and mixed with low agitation for 30 minutes.
5. The cream was processed under UHT conditions using a MicroThermics thermal processor with the follow in parameters:
   Preheat 78° C.
   Sterilize 138° C.
   1^{st} cooler 78° C.
   Homogenize 2000/500 psi
   2^{nd} cooler 10° C.
      Creams were tested for viscosity 2 hours after production. Viscosity and whipping characteristics were tested after 24 hours and approximately 3 weeks.

The results of Examples 31 to 36 can be seen in Table 5.

TABLE 5
24% Fat Whipping Cream
24% Fat Cream

| | | | | | | | Cream Mean | Cream Viscosity, cps | | |
|---|---|---|---|---|---|---|---|---|---|---|
| Exam- | | Over- | Stiffness, | Syneresis, | Whipping | Foam | Particle Size, | 2 | 24 | 3 |
| ple | Polymer Type | run | F(g) | % | Time | Appearance | μm | hours | hours | weeks |
| 31 | AeroWhip ® 631EZ HPC, | 115 | 109 | 124 | 6 m 15 s | medium | 5.29 | 976 | 2008 | 4120 |
| | 0.2% | | | | | peaks | | | | |
| 32 | Avicel ® CL 611 MCC, 0.5% | 117 | 117 | 150 | 7 m 15 s | medium | 4.1 | 816 | 902 | 4360 |
| | | | | | | peaks | | | | |
| 33 | AeroWhip ® 631EZ HPC, | 127 | 134 | 145 | 5 m 30 s | stiff, dry | 3.27 | 498 | 596 | 761 |
| | 0.1% Avicel ® CL 611 MCC, | | | | | peaks | | | | |
| | 0.2% | | | | | | | | | |
| 34 | Avicel ® RC 591 MCC, 0.2% | 108 | 63 | 173 | 8 m | medium | 5.02 | 713 | 862 | 43800 |
| | | | | | | peaks | | | | |
| 35 | AeroWhip ® 631EZ HPC, | 127 | 108 | 145 | 6 m | medium | 2.41 | 927 | 2198 | 6210 |
| | 0.1% Avicel ® RC 591 | | | | | peaks | | | | |
| | MCC, 0.2% | | | | | | | | | |
| 36 | Benecel MP843 0.1%, | 109 | 75 | 177 | 8 m | medium | 1.87 | 733 | 823 | 906 |
| | Avicel ® RC 591 MCC, 0.2% | | | | | peaks | | | | |

As shown in Table 5, the performance of the combination of HPC and MCC of Example 33 can be seen to be superior to both Examples 31 and 32 where just HPC or MCC are used separately in the whipped cream composition.

Also shown in Table 5, the viscosity of the compositions of Example 33 and 36 can be seen to be more stable over a period of three (3) weeks when compared to the stability observed in Examples 31 and 32 and 34 and 35.

Other aerated dairy systems or food foams such as ice cream and desserts may benefit from combinations of HPC and MCC.

### EXAMPLES 37 AND 38-NON-DAIRY COMPOSITIONS

Examples of compositions made without the inclusion of milkfat or through the use of an aqueous phase derived from dairy are set forth in the following examples. One advantage of producing a non-dairy composition as opposed to a dairy composition that the protein content of the resultant non-dairy composition may be adjusted, as needed. Non-dairy compositions may be produced that are protein-free, if desired. In the following formulations, Example 37 was produced as a protein-free composition while Example 38 was formulated to contain protein. The source of the protein in Example 38 was sodium caseinate.

The formulations of these non-dairy cream compositions are as follows:

| | Example 37 | Example 38 |
|---|---|---|
| | wt % | wt % |
| Water | 58.9 | 57.9 |
| HPC (AeroWhip ® 621 EZ, | 0.3 | 0.3 |
| Hercules Incorporated) | | |
| CMC (Aqualon ® 7H3SXF, | 0.05 | 0.05 |
| Hercules Incorporated) | | |
| polysorbate 60 (Durfax 60, Loders Croklaan) | 0.5 | 0.5 |
| sodium caseinate (Alanate 180) | 0 | 1.0 |
| sugar | 15.0 | 15.0 |
| salt | 0.1 | 0.1 |
| glycerol lacto esters (Durlac 100W, | 0.1 | 0.1 |
| Loders Croklaan) | | |
| partially hydrogenated palm | 25.0 | 25.0 |
| kernel oil (Paramount B WL) | | |
| Mono&diglycerides (Atmos 150) | 0.05 | 0.05 |
| Total | 100% | 100% |

1. Add HPC and CMC to cold water, Stir with good agitation
2. Add Durfax 60 to polymer mixture, stir with good agitation.
3. Add sugar, salt and Durlac 100 W to water slurry.
4. Add Alanate 180 to slurry, mix 20 minutes.
5. Melt Paramount B and Atmos 150 over low heat.
6. Blend warm liquid fat into aqueous phase with stirring.
7. Heat 76° C. for 5 minutes, homogenize with Silverson for 10 minutes.
8. Cool in water bath.

The non-dairy compositions of Examples 37 and 38 were subsequently whipped to produce food foams. These food foams were evaluated using the same evaluation methods as were used in Examples 31 to 36. The results of these evaluations are found in Table 6.

TABLE 6
Non-Dairy Compositions
25% Fat Nondairy Cream

| | Formulation | | Stiffness, | Syneresis, | Whipping | Foam |
|---|---|---|---|---|---|---|
| Example | Type | Overrun | F(g) | % | Time | Appearance |
| 37 | Protein-free | 158 | 137 | 115 | 4 m | medium peaks |
| 38 | With protein | 153 | 180 | 103 | 4 m | stiff peaks |

The above results demonstrate that non-dairy compositions of the present invention may be used to produce food foams having desirable characteristics. While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed:

1. A cream composition comprising
a cellulose ether compound,
a water-soluble or water-swellable hydrocolloid stabilizer,
a fat, and
an aqueous phase,
wherein the cellulose ether compound is selected from the group consisting of hydroxypropyl cellulose (HPC), hydroxypropyl methylcellulose (HPMC), methyl hydroxyethyl cellulose(MHEC), methyl cellulose (MC) and ethyl cellulose (EC) and blends thereof.

2. The cream composition of claim 1 wherein the water-soluble or water-swellable hydrocolloid stabilizer is selected from the group consisting of microcrystalline cellulose, hydroxyethyl cellulose, carboxymethyl cellulose, starch, carboxymethyl starch, hydrophobically modified starch, guar, pectin, pectinate, pectate, xanthan, carrageenan, agar, gellan, scleroglucan, betaglucan, alginate and alginic acid, propylene glycol-alginate, gum arabic, gum tragacanth, konjac gum, chitin, chitosan, locust bean gum, gelatin, and mixtures thereof.

3. The cream composition of claim 2, wherein the fat comprises milkfat.

4. The cream composition of claim 3, wherein the cream composition further comprises an emulsifier.

5. The cream composition of claim 4, wherein the emulsifier is selected from the group consisting of fatty acid esters of glycerol, hydroxycarboxylic acid, citric, acetic, lactylate, polyglycerol, ethylene or propylene glycol, ethoxylated derivatives of monoglycerides, and sorbitan fatty acid esters, lecithin, sodium stearoyl lactate.

6. The cream composition of claim 2, wherein the fat comprises a vegetable fat.

7. The composition of claim 6, wherein the cream composition further comprises an emulsifier.

8. The composition of claim 7, wherein the emulsifier is selected from the group consisting of fatty acid esters of glycerol, hydroxycarboxylic acid, citric, acetic, lactylate, polyglycerol, ethylene or propylene glycol, ethoxylated derivatives of monoglycerides, and sorbitan fatty acid esters, lecithin, sodium stearoyl lactate.

9. The cream composition of claim 3, wherein the aqueous phase further comprises protein, lactose, minerals, and vitamins, derived from a cow, ewe, goat or other mammal.

10. The cream composition of claim 6, wherein the aqueous phase is derived from a plant source.

11. The cream composition of claim 1, wherein the cream composition exhibits an overrun of greater than 50%.

12. The cream composition of claim 11, wherein the cream composition exhibits an overrun of greater than 95%.

13. The cream composition of claim 12, wherein the cream composition exhibits an overrun of greater than about 110%.

14. The cream composition of claim 13, wherein the cream composition exhibits an overrun of greater than about 125%.

15. The cream composition of claim 2, wherein the cellulose ether compound comprises HPC and wherein the water-soluble or water-swellable hydrocolloid stabilizer comprises microcrystalline cellulose.

16. The cream composition of claim 15, wherein the water-soluble or water-swellable hydrocolloid stabilizer further comprises carrageenan.

17. The cream composition of claim 2, wherein the cellulose ether compound comprises HPMC and wherein the water-soluble or water-swellable hydrocolloid stabilizer comprises microcrystalline cellulose.

18. The cream composition of claim 15, wherein the water-soluble or water-swellable hydrocolloid stabilizer further comprises carrageenan.

19. The cream composition of claim 2, wherein the cellulose ether compound comprises HPC and wherein the water-soluble or water-swellable hydrocolloid stabilizer comprises carboxymethyl cellulose.

20. The cream composition of claim 19, wherein the water-soluble or water-swellable hydrocolloid stabilizer further comprises carrageenan.

21. The cream composition of claim 2, wherein the cellulose ether compound comprises HPMC and wherein the water-soluble or water-swellable hydrocolloid stabilizer comprises carboxymethyl cellulose.

22. The cream composition of claim 21, wherein the water-soluble or water-swellable hydrocolloid stabilizer further comprises carrageenan.

23. The cream composition of claim 15, wherein the cellulose ether compound further comprises HPMC.

24. The cream composition of claim 16, wherein the cellulose ether compound further comprises HPMC.

25. The cream composition of claim 19 wherein the cellulose ether compound further comprises HPMC.

26. The cream composition of claim 15 wherein the water-soluble or water-swellable hydrocolloid stabilizer further comprises guar.

27. The cream composition of claim 15 wherein the water-soluble or water-swellable hydrocolloid stabilizer further comprises alginate.

28. The cream composition of claim 2 wherein the cellulose ether compound comprises HPC and the water-soluble or water-swellable hydrocolloid stabilizer further comprises guar.

29. The cream composition of claim 15 wherein the cellulose ether compound comprises HPMC and the water-soluble or water-swellable polymer further comprises guar.

30. The cream composition of claim 15 wherein the water-soluble or water-swellable hydrocolloid stabilizer further comprises locust bean gum.

31. The cream composition of claim 1 wherein the cellulose ether compound is used in amounts ranging from greater than about 0.01% based on the total weight of the cream composition.

32. The cream composition of claim 31 wherein the cellulose ether compound is used in amounts ranging from greater than about 0.01% to less than about 1% based on the total weight of cream composition

33. The cream composition of claim 1 wherein the water-soluble or water-swellable hydrocolloids are included in the cream composition at concentrations of greater than about 0.001% by weight based on the total weight of cream composition.

34. The cream composition of claim 33 wherein the water-soluble or water-swellable hydrocolloids are included in the cream composition at concentrations in the cream composition at concentrations in the range of greater than about 0.001% by weight to about 0.75% weight based on the total weight of cream composition.

35. A process for producing a cream compositions comprising:
a) combining a cellulose ether compound, a water-soluble or water-swellable hydrocolloid stabilizer, a fat and an aqueous phase together to obtain a cream composition,
c) applying heat to the cream composition
d) optionally homogenizing the cream composition, and
e) cooling the cream composition,
wherein the cellulose ether compound is selected from the group consisting of hydroxypropyl cellulose (HPC), hydroxypropyl methylcellulose (HPMC), methyl hydroxyethyl cellulose(MHEC) and methyl cellulose (MC).

36. The process for producing the cream composition of claim 35, wherein the heat is applied to the cream composition during a pasteurization process.

37. The process for producing the cream composition of claim 35, wherein the heat is applied to the cream composition during an Ultra High Temperature (UHT) treatment.

38. The process for producing the cream composition of claim 37, wherein the process further comprises the step of aseptic packaging of the cream composition.
